(19) United States
(12) Patent Application Publication
(10) Pub. No.: US 2023/0401752 A1
(43) Pub. Date: Dec. 14, 2023

(54) TECHNIQUES USING VIEW-DEPENDENT POINT CLOUD RENDITIONS

(71) Applicant: InterDigital CE Patent Holdings, SAS, Paris (FR)

(72) Inventors: Pierre Andrivon, LIFFRE (FR); Celine Guede, Cesson Sevigne (FR); Julien Ricard, Plouër-sur-Rance (FR); Jean-Eudes Marvie, BETTON (FR)

(73) Assignee: InterDigital CE Patent Holdings, SAS, Paris (FR)

(21) Appl. No.: 18/030,635

(22) PCT Filed: Oct. 12, 2021
(86) PCT No.: PCT/EP2021/078148

§ 371 Date: Apr. 6, 2023

(30) Foreign Application Priority Data
Oct. 12, 2020 (EP) 20306195.7

(51) Int. Cl. G06T 9/00; G06T 7/73; G06T 15/20; G06T 5/50

(52) U.S. Cl. CPC G06T 9/001; G06T 7/75; G06T 15/205; G06T 5/50; G06T 2207/20221; G06T 2207/30244

(57) ABSTRACT

A method and device are provided for rendering an image. The method comprises receiving an image from at least two different camera positions and determining a camera orientation and at least one image attribute associated with each of the positions. A model is then generated of the image based on the attribute and camera orientation associated with the received camera positions of the image. The model is enabled to provide a virtual rendering of the image at a plurality viewing orientations and selectively providing appropriate attributes associated with the viewing orientation.

### TECHNICAL FIELD

The present disclosure generally relates to image rendering and more particularly to image rendering using point cloud techniques.

### BACKGROUND

Volumetric video capture is a technique that allows moving images, often in real scenes, be captured in a way that can be viewed later from any angle. This is very different than regular camera captures that are limited in capturing images of people and objects from a particular angle only. In addition, video capture allows the captures of scenes in a three-dimensional (3D) space. Consequently, data that is acquired can then be used to establish immersive experiences that are either real or alternatively generated by a computer. With the growing popularity of virtual, augmented and mixed reality environments, volumetric video capture techniques are also growing in popularity. This is because the technique uses visual quality of photography and mixes it with the immersion and interactivity of spatialized content. The technique is complex and combines many of the recent advancements in the fields of computer graphics, optics, and data processing.

Volumetric visual data is typically captured from real world objects or provided through use of computer generated tools. One popular method of providing common representation of such objects is through use of point cloud. A point cloud is a set of data points in space that represent a three dimensional (3D) shape or object. Each point has its set of X, Y or Z coordinates. Point cloud compression (PCC) is a way of compressing volumetric visual data. A subgroup of MPEG (Motion Picture Expert Group) works on the development of PCC standards. MPEG PCC requirements for point cloud representation require view-dependent attributes per 3D position. A patch, or to some extent points of a point cloud, is viewed according to the viewer angle. However, viewing any 3D object in a scene, according to different angles may require modification of different attributes (e.g. color or texture) because certain visual aspects may be a function of the viewing angle. For example, properties of light can impact the rendering of an object because angle of viewing can change the color and shading of it depending on the material of the object. This is because texture can be dependent on incident light wavelength. Unfortunately, current prior art does not provide realistic views of objects under all conditions an angles. Modulated attributes according to viewer angle for a captured or even scanned image does not always provide a faithful rendition of the original content. Part of the problem is because even when preferred viewer angle is known when rendering the image, the camera settings and the angle that were used to capture the image as relating to 3D attributes are not always documented in a way that can provide a realistic rendering possible at a later time and 3D point cloud attributes can become uncertain at some viewing angles. Consequently, techniques are needed to address these short comings of the prior art when rendering views and images that are realistic.

### SUMMARY

In one embodiment, a method and device are provided for rendering an image. The method comprises receiving an image from at least two different camera positions and determining a camera orientation and at least one image attribute associated with each of the positions. A model is then generated of the image based on the attribute and camera orientation associated with the received camera positions of the image. The model is enabled to provide a virtual rendering of the image at a plurality of viewing orientations and selectively providing appropriate attributes associated with the viewing orientation.

In another embodiment, a decoder and encoder are provided. The decoder has means for decoding from a bitstream having one or more attributes data, the data having at least an associated position corresponding to an attribute capture viewpoint. The decoder also has a processor configured to reconstruct a point cloud from the bitstream using all said attributes received, and provide a rendering from the point cloud. The encoder can encode the model and the rendering.

### BRIEF DESCRIPTION OF THE DRAWINGS

The teachings of the present disclosure can be readily understood by considering the following detailed description in conjunction with the accompanying drawings, in which:

FIG. 1 is an illustration of an example of a camera rig and a virtual camera rendering an image;

FIG. 2 is similar to FIG. 1 but the camera is rendering the image at different angles relative to system coordinates;

FIG. 3 is an illustration of an octahedral map of the octant of a sphere which projects onto a plane and unfolds into a unit square;

FIG. 4 is an illustration of a dereferencing point value and a neighbor using octahedral modeling;

FIG. 5 is an illustration of table that provides capture positons as per one embodiment;

FIG. 6 illustrates an alternate table with similar information to that provided in FIG. 5;

FIG. 7 is a flowchart illustration according to an embodiment;

FIG. 8 schematically illustrates a general overview of an encoding and decoding system according to one or more embodiments; and

FIG. 9 is a flowchart illustration of an encoder according to an embodiment.

To facilitate understanding, identical reference numerals have been used, where possible, to designate identical elements that are common to the figures.

### DETAILED DESCRIPTION OF PREFERRED EMBODIMENTS

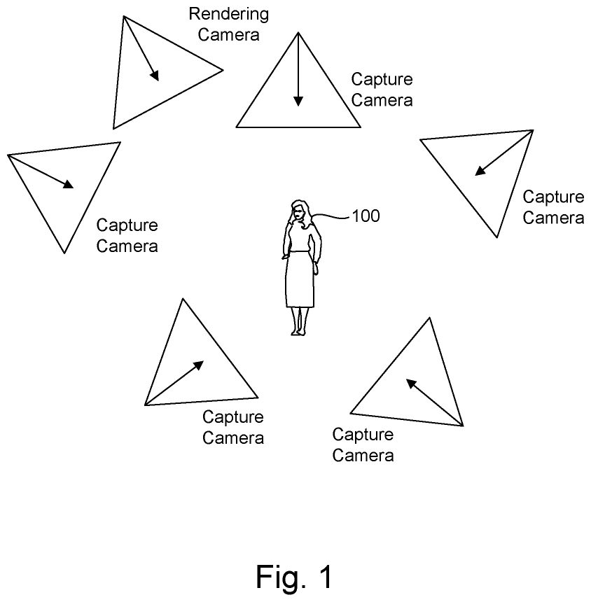

FIG. 1 provides an example of a camera rig and a virtual camera providing a rendering of an image or video. When providing the rendering, the camera capture parameters must be known to at least a processor that is proving the rendering in order to select the proper attributes (e.g. color or texture) point samples using a point cloud technology. The image captured in FIG. 1, is denoted by numerals 100. The image can be of an object, a scene or part of a video or live stream. When this is a digital image, such as a video image, a TV image, a still image or an image generated by a video recorder or a computer or even a scanned image, the image traditionally consist of pixels or samples arranged in horizontal and vertical lines. The number of pixels in a single image is typically in the tens of thousands. Each pixel typically contains certain characteristics such as luminance and chrominance information. The sheer quantity of information to be conveyed from an image is difficult if not impossible to transmit over traditional broadcast or broadband networks and compression techniques are used to often transmit the image such as from an encoder to an image decoder. Many of the compression schemes are compliant with MPEG (Motion Picture Expert Group) standards which will be provided with different embodiments of the present invention.

Images are captured and presented in two dimensions such as the one provided in FIG. 1 at 100. It is challenging to provide realistic 3D images or renderings that provide 3D feel of the two dimensional (2D) image. One technique used recently utilizes volumetric video capture as discussed earlier especially one that uses point cloud technology. A point cloud provides a set of data points. Each point has a set of X, Y and Z coordinates in space and together this set of points represent a 3D shape or object. When compression schemes are used, point cloud compression (PCC), includes huge data sets that describes three dimensional points associated with additional information such as distance, color, and other characteristics and attributes.

In some embodiments as will be discussed, both PCC and MPEG standards are used. The MPEG PCC requirements for point cloud representation require view dependent attributes per 3D position. A patch, for example as specified in V-PCC (FDIS ISO/IEC 23090-5, MPEG-I part 5), or to some extent points of a point cloud, is viewed according to the viewer angle. However, viewing a 3D object in a scene, represented as a point cloud, according to different angles may show different attribute values (e.g. color or texture) function of the viewing angle. This is due to property of the material composing the object. For example the reflection of light on the surface (isotropic, non-isotropic, etc.) can change the way the image is rendered. Properties of light in general impacts the rendering, as materials reflection of the surfaces of an object are dependent on incident light wavelength.

The prior art does not provide solution that allow modulating rendition attributes according to viewer angle, for either captured or even scanned material under different viewpoints faithfully because camera settings and the angles that were used to capture each 3D attributes are not documented in most cases and 3D attributes become undertain from certain angles.

In addition when using PCC and MPEG standards, the view-dependent attributes do not address the 3D graphics as intended despite the tiling, volumetric SEI and viewport SEI messages. In addition, while some information is carried in the V-PCC stream, the point attributes of a same type captured by a multi-angle acquisition system (that might be virtual in case of CGI), may be stored across attributes “count” (ai_attribute_count in attribute_information(j) syntax structure) and identified by an attribute index (vuh_attribute_index, indicating the index of the attribute data carried in the attribute video data unit) that causes some issues. For example, there is no information on acquisition system position or angle used to capture a given attribute according to a given angle. Thus, such a collection of attributes stored in the attributes dimension can only be modulated arbitrarily according to the angle of viewing of the viewer as there is no relationship between capture attributes and their capture position. This leads to a number of disadvantages and weaknesses such as lack of information on the position of the captured attributes, arbitrary modulation of content during rendering and unrealistic renditions that are unfaithful to the original content attributes.

In a point cloud arrangement, the attributes of a point may change according to the viewpoint of the viewer. In order to capture these variations, the following elements need to be considered:
1) the position of the viewer relatively to observed point cloud,
2) a collection of attribute values for a number of points of the point cloud according to different angles of capture, and,
3) the position of the capture camera for a given set of captured attribute value (capture position)

The video-based PCC (or V-PCC) standards and specification does address some of these issues in providing the position of the viewer (Item 1) through the “viewport SEI messages family” which enables rendering view-dependent attributes. Unfortunately, however, this, as can be understood, presents rendering issues. The rendering is affected because in some of these cases there is no indication about the position from where attributes were captured. (It should be noted that in one embodiment, ai_attribute_count only indexes the lists of captured attributes however there is no information where they were captured from). This can be resolved by different possibilities in storing the capture position in a descriptive metadata once generated and calculated.

In Item 2, it should be noted that certain capture camera may not capture the attributes (colors) of the object (for instance if you consider a head, the camera in front will capture the cheeks, eyes . . . but not the rear of the head . . . ) so that each point is not provided with an actual attributes for every angle.

The position of the camera used to capture attributes is provided in an SEI message. This SEI has the same syntax elements and the same semantics as the viewport position SEI message except that, as it qualifies capture camera position:
“viewport” is replaced in the semantics by “capture”
cp_atlas_id specifies the ID of the atlas that corresponds to the associated current V3C unit. The value of cp_atlas_id shall be in the range of 0 to 63, inclusive.
cp_attribute_index indicates the index of the attribute data associated to camera position (i.e. equal to the matching vuh_attribute_index). The value of cp_attribute_index shall be in the range of 0 to (ai_attribute_count[cp_atlas_id]−1).
cp_attribute_partition_index indicates the index of the attribute dimension group associated to camera position.

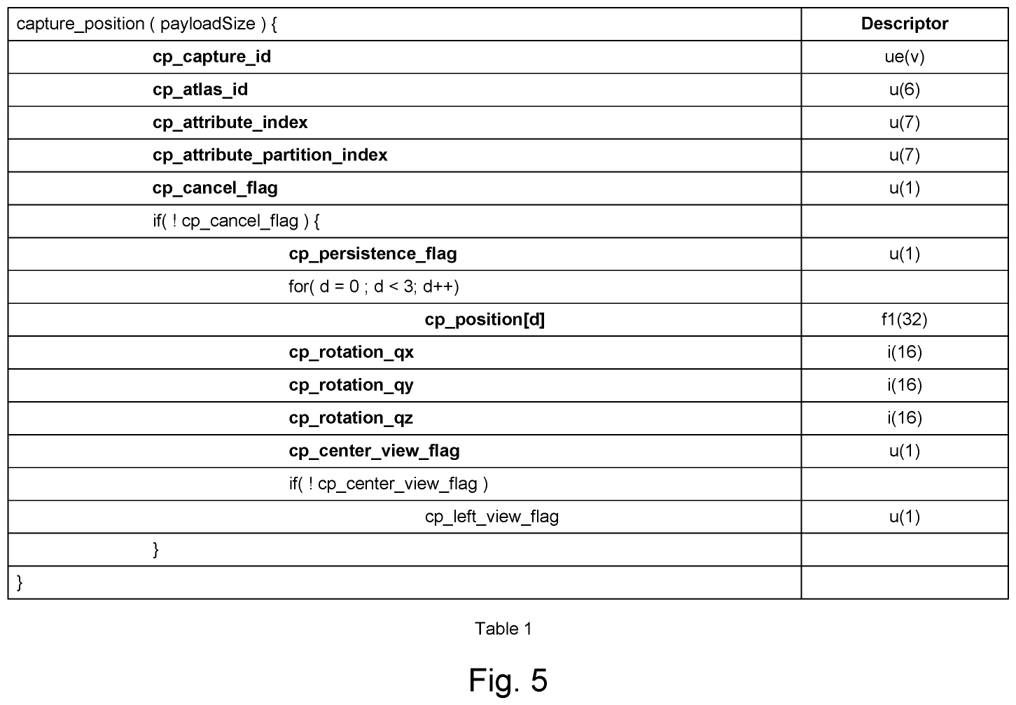

More information about the specifics of this is provided in Table 1 as shown in FIG. 5. Information can be stored in a general location and be retrieved from a repository such as an atlas for later use. For example as shown, possibly the cp_atlas_id is not signaled in the bitstream and its value is inferred from the V3C unit present in the same access unit that the capture position SEI message (i.e. equal to vuh_atlas_id) or it takes the value of the preceding or following V3C unit.

Alternatively, the cp_attribute_index is not signaled and derived implicitly as being in the some order than the attribute data stored in the stream (i.e. order of derived cp_attribute_index is the same as vuh_attribute_index in decoding/stream order).

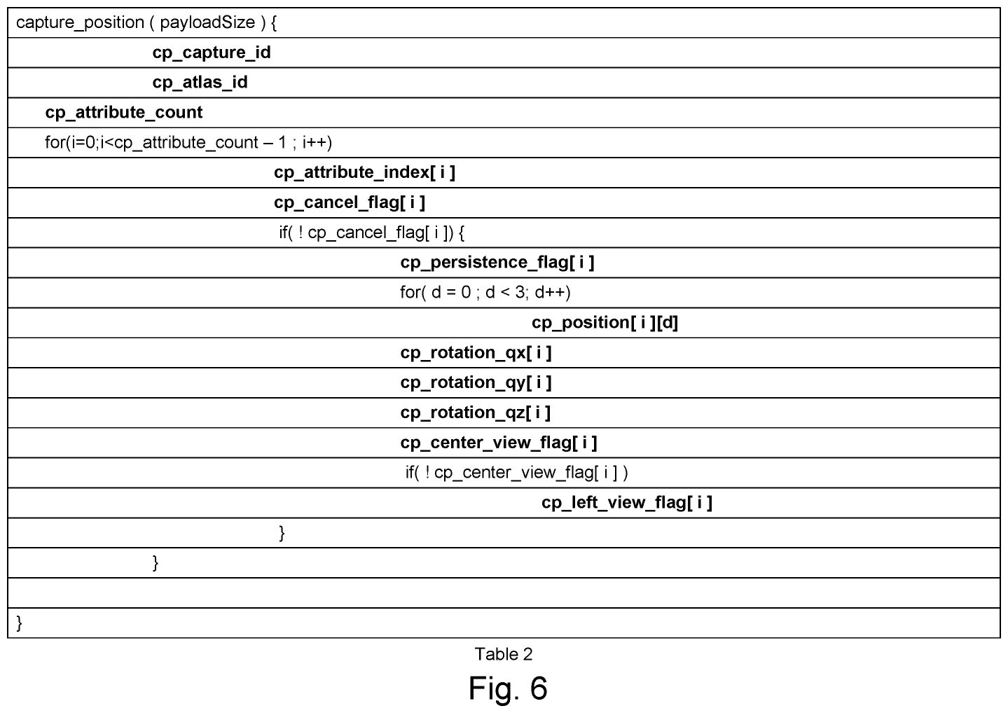

In yet another alternative embodiment, the capture position syntax structure loops on the number of attribute data sets presents. The loop size may be explicitly signaled (e.g. cp_attribute_count) or inferred from ai_attribute_count[cp_atlas_id]−1. This is shown in FIG. 6 and table 2.

In addition, alternatively or optionally, a flag can be provided to indicate in the capture position SEI message whether the capture position is the same as the viewport position. When this flag is set equal to 1, cp_rotation-related (quaternion 4 rotation) and cp_center_view_flag syntax elements are not transmitted.

Alternatively at least an indicator can be provided that specifies whether attributes are view-independent according to an axis (x, y, z) or directions. Indeed, view-dependency may only occur relatively to a certain axis or position.

In another embodiment, again additionally or optionally to one of previous examples, an indicator associates sectors around the point cloud with attributes data sets identified by cp_attribute_index. Sector parameters such as angle and distance from the center of the reconstructed point cloud may be fixed or signaled.

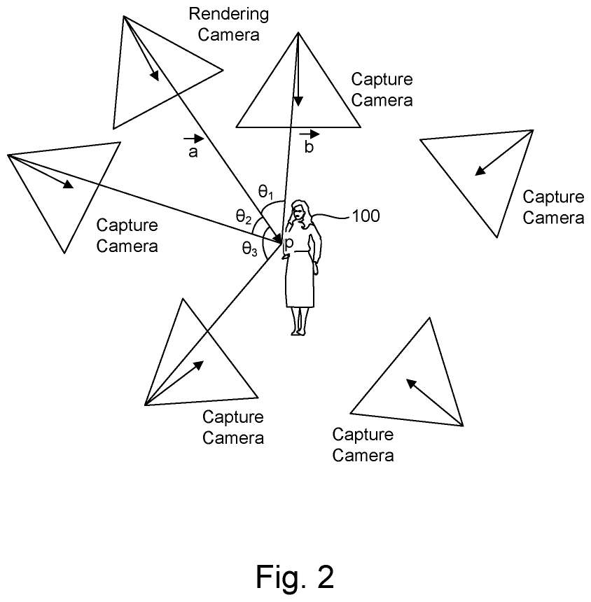

In an alternate embodiment, the capture position can be provided via processing of SEI messages. This can be discussed in conjunction with FIG. 2. FIG. 2 is a capture camera selection fo the same image 100 but having in this example three angles for rendering.

In one embodiment, using the attributes discussed. The angles are relative, in on embodiment to a system coordinate. In this embodiment, the angles (or rotation) are determined for example with a variety of models known to those skilled in the art such as the quaternion model. (see cp_attribute_index (and optionally, cp_attribute_partition_index which links the position of attributes capture system to the index of the attribute information—i.e. the matching vuh_attribute_index, the index of the attribute data carried in the attribute video data unit—it relates to). This information enables matching attributes values seen from the capture system (identified by cp_attribute_index) with attributes values seen from the viewer (possibly identified by the viewport SEI message). Typically, the attribute data set selected is the one for which the viewport position parameters (as indicated by the viewport SEI message) are equal or near (according to some thresholds and some metrics like Mean Square Error) the capture position parameters (as indicated by the capture position SEI message).

In one embodiment, at rendering, for each point of the point cloud to be rendered by:
finding the set of n (n in [1, ai_attribute_count[j]] is user defined at client side or encoded as metadata in the SEI, a simple default value may be 1) nearest capture viewpoints from the capture position SEI message in terms of angular distance (see FIG. 2) using dot product (a is vector between rendering camera and point, b is vector between capture camera and point)

$$cos θ = \begin{matrix}a \cdot b \\ \vert a \vert \cdot \vert b \vert\end{matrix}$$

for each capture viewpoint previously selected, use its index i (cp_attribute_index) in the SEI to de-reference the point value Ci.
then, as an example, use a proportional blending among the n values weighted by the angular distance to compute the final point value.
   ((180/θ1)*C1+(180/θ2)*C2+)/n

Alternatively, in a different embodiment the set of captured viewpoints can be selected by “ALL” the capture viewpoints within a specific maximum angular distance and then blend in the same way as depicted previously.

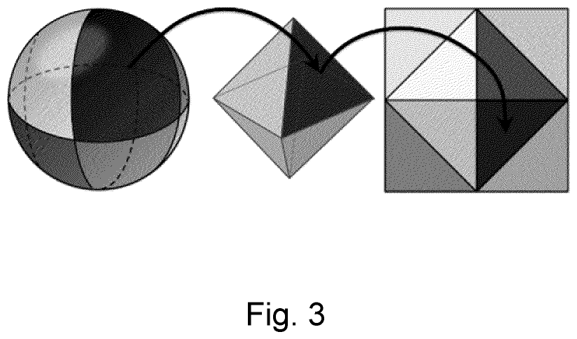

FIG. 3 provides an octahedral representation which maps the octants of a sphere to the faces of an octahedron, which it projects onto the plane and unfolds into a unit square. FIG. 3 can be used as another way to encode information for rendering by using an implicit model for the coding of per-point directional sectors. In this embodiment and the case of this example, the capture data are always encoded in a pre-defined order in the point multi-value table (attributes data) and the data is dereferenced according to the model that is used. For instance, one could use the octahedral model [2,3] which allows for regular discretization of a sphere (see FIG. 2) in 8 sections (i.e. 8 view-points). In this case the unit square can be discretized according to horizontal and vertical axis of the square unit to contain the n possible per-point values (e.g. 5×5=25 camera positions at maximum).

Therefore, only need is to encode the model type (i.e. Octahedral, or other let for further use) and the discretization square size (e.g. n=11 at maximum). These two values stand for all the points and are very compact to store. As an example, the scan order of the unit square is raster scan or clockwise or anti-clockwise. An exemplary syntax can be provided such as:

| | Descriptor |
|---|---|
| capture_mapping ( payloadSize ) { | |
| cm_capture_id | ue(v) |
| cm_model_idc | u(6) |
| if (cm_model_idc = = 0) | |
| cm_square_size_minus1 | u(6) |
| } | |

where:
if exist, cm_atlas_id specifies the ID of the atlas that corresponds to the associated current V3C unit. The value of cp_atlas_id shall be in the range of 0 to 63, inclusive.
cm_model_idc indicates the model of representation (or mapping) for purpose of discretization of the capture sphere. cm_model_idc equal to 0 indicates that the discretization model is an octahedral model. Other values are reserved for future use.
cm_square_size_minusl+1 represents the size of the unit square representative of the octahedral model in units of points per attribute values. Default value can be determined (such as 11). Additionally, syntax elements can be provided to permit the camera positions to be constrained in the square (e.g. upper part, right part, or upper-right part.).

Alternatively, only the same representation model can be used and it is not signalled in the bitstream. Filling the actual regular values from an unregular capture rig can be done by using the algorithm presented in previous section at the compression stage with a user defined value of n.

Alternatively, only the same representation model is used and it is not signalled in the bitstream. Filing the actual regular values from an unregular capture rig can be done by using the algorithm presented previously at a point where a user can define a value of n for compression.

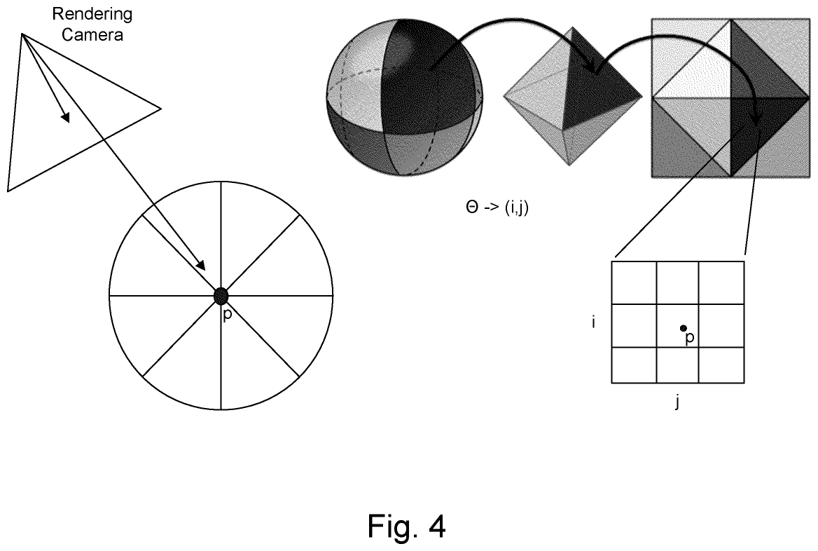

Alternatively, an implicit model SEI message can be used for processing as shown in FIG. 4. In FIG. 4, the derefencing point value and neighbors are used in the previous octahedral model. In this embodiment, at rendering, angular coordinates can be used in global coordinates to retrieve the nearest value that can be used. This will lead to dereferencing a value in the point value (e.g. the color) table with ai_attribute_count values: V=Val[i*n+j] where for instance n=11 and i and j are indices in an horizontal and vertical system coordinates associated to the square unit. In one embodiment, a more complex filtering could use bilinear using the nearest neighbors in the octahedral map for fast processing.

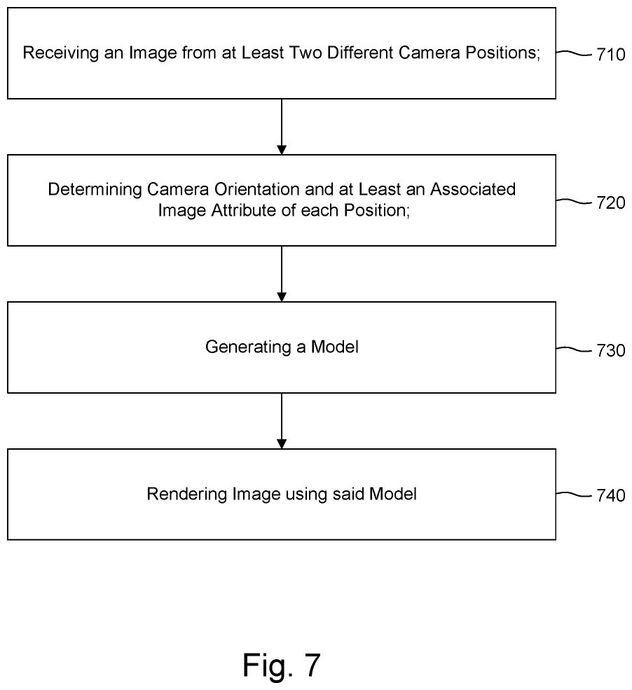

FIG. 7 provides a flowchart illustration for processing images according to one embodiment. As shown in step 710 (S710), an image is from at least two different camera positions. In S720, a camera orientation is determined. The camera orientation can include a camera angle, a rotation, a matrix or other similar orientation as can be understood by one skilled in the art. In one embodiment, the angle can even be a composite angle determined by several angles according to the system coordinates (a rotation angle x, y, and z expressed with quaternion model). In other examples, the camera orientation can be the position of the camera relative of a 3D rendering of said image to be rendered. It can alternatively be represented as a rotation matrix constructed relative to coordinates in which the 3D model is to be represented. In addition, in this step at least one image attribute associated with each positions is also determine. In S730 a model is generated. The model can be a 3D or 2D point cloud model. In one embodiment, the model is constructed with all attributes (but some can be provided in the rendering selectively see S740). The model is of the image to be rendered and is based on the attribute and camera orientation associated with the received camera positions of the image. In S740 a virtual rendering of the image is provided. The rendering is of any any viewing orientation and selectively provides appropriate attributes associated with the viewing orientation. In one embodiment, a user can select a preferred viewpoint for the rendering to be provided.

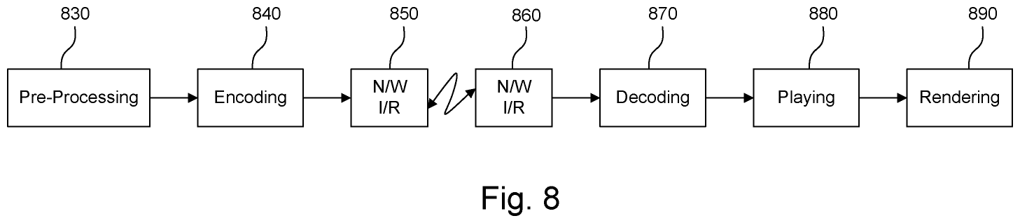

FIG. 8 schematically illustrates a general overview of an encoding and decoding system according to one or more embodiments. The system of FIG. 8 is configured to perform one or more functions and can have a pre-processing module 830 to prepare a received content (including one more images or videos) for encoding by an encoding device 840. The pre-processing module 830 may perform multi-image acquisition, merging of the acquired multiple images in a common space and the like, acquiring of an omnidirectional video in a particular format and other functions to allow preparation of a format more suitable for encoding. Another implementation might combine the multiple images into a common space having a point cloud representation. Encoding device 840 packages the content in a form suitable for transmission and/or storage for recovery by a compatible decoding device 870. In general, though not strictly required, the encoding device 840 provides a degree of compression, allowing the common space to be represented more efficiently (i.e., using less memory for storage and/or less bandwidth required for transmission). In the case of a 3D sphere mapped onto a 2D frame, the 2D frame is effectively an image that can be encoded by any of a number of image (or video) codecs. In the case of a common space having a point cloud representation, the encoding device may provide point cloud compression, which is well known, e.g., by octree decomposition. After being encoded, the data, is sent to a network interface 850, which may be typically implemented in any network interface, for instance present in a gateway. The data can be then transmitted through a communication network, such as the internet. Various other network types and components (e.g. wired networks, wireless networks, mobile cellular networks, broadband networks, local area networks, wide area networks, WiFi networks, and/or the like) may be used for such transmission, and any other communication network may be foreseen. Then the data may be received via network interface 860 which may be implemented in a gateway, in an access point, in the receiver of an end user device, or in any device comprising communication receiving capabilities. After reception, the data are sent to a decoding device 870. Decoded data are then processed by the device 880 that can be also in communication with sensors or users input data. The decoder 870 and the device 880 may be integrated in a single device (e.g., a smartphone, a game console, a STB, a tablet, a computer, etc.). In another embodiment, a rendering device 890 may also be incorporated. In one embodiment, the decoding device 870 can be used to obtain an image that includes at least one color component, the at least one color component including interpolated data and non-interpolated data and obtaining metadata indicating one or more locations in the at least one color component that have the non-interpolated data.

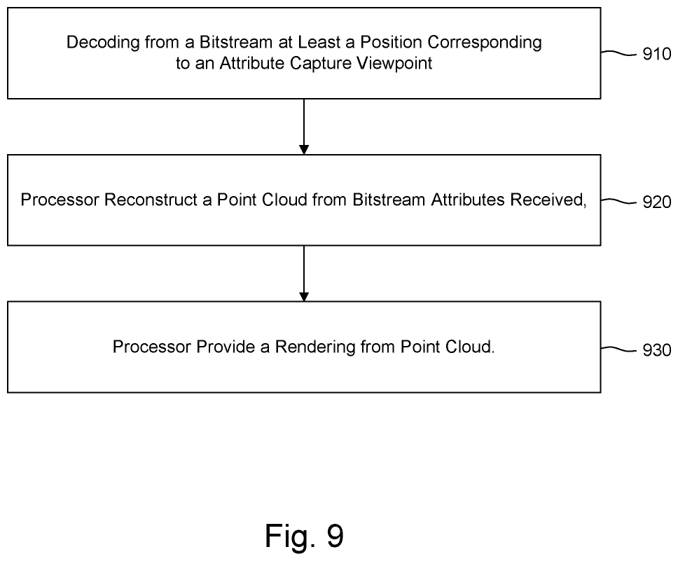

FIG. 9 is a flowchart illustration of a decoder. In one embodiment, the decoder comprises means for decoding from a bitstream at least a positon corresponding to an attribute capture viewpoint as shown at S910. The bitstream can have one or more attributes that are associated with the position corresponding to the attribute capture viewpoint. The decoder has at least one processor that is configured to reconstruct reconstruct a point cloud from the bitstream using all said attributes received as shown at S920. The processor can then provide a rendering from the point cloud as shown at S930.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application

What is claimed is:

1.-20. (canceled)

21. A method for processing images comprising:
receiving a plurality of images, wherein the plurality of images were each captured from one of a plurality of camera positions;
determining a camera position and an image attribute associated with each of the plurality of images; and
generating a bitstream for the plurality of images, wherein the bitstream comprises metadata that provide an indication of the image attribute associated with each of the plurality of camera positions.

22. The method of claim 21, wherein the metadata provide an index of the image attribute associated with each of the plurality of camera positions.

23. The method of claim 21, wherein the metadata provide an identification of an atlas that corresponds to a volumetric coding unit.

24. The method of claim 21, wherein the metadata provide an index of an attribute dimension group associated with each of the plurality of camera positions.

25. The method of claim 21, wherein the image attribute comprises texture or chroma of each of the plurality of images.

26. The method of claim 21, wherein the metadata is provided via one or more SEI messages.

27. The method of claim 21, wherein the metadata include a flag that indicates whether the camera position from which an image of the plurality of images was captured is the same as a viewport position associated with the image.

28. The method of claim 21, wherein the metadata comprises an indicator that specifies whether the image attribute associated with an image of the plurality of images is view-independent according to one or more axes or directions.

29. A method comprising:
receiving a bitstream that comprises data representing a plurality of images, wherein the plurality of images were each captured from one of a plurality of camera positions, and wherein the bitstream comprises metadata that provides an indication of an image attribute associated with each of the plurality of camera positions;
selecting metadata based on an orientation for rendering one or more images at the decoder, wherein the rendering orientation is different from each of the plurality of camera positions; and
rendering the one or more images using the selected metadata.

30. The method of claim 29, further comprising:
rendering the one or more images using the image attribute associated with at least one of the plurality of camera positions.

31. The method of claim 29, wherein the metadata is selected based on an angular distance between the rendering orientation and the plurality of camera positions.

32. The method of claim 31, wherein the selected metadata provides an indication of an image attribute associated with a camera position of the plurality of camera positions that has the smallest angular distance to the rendering orientation.

33. The method of claim 31, wherein the selected metadata provides indications of image attributes associated with two or more of the camera positions of the plurality of camera positions that are within a threshold angular distance of the rendering orientation.

34. The method of claim 29, wherein the metadata is selected based on one or more of the plurality of camera positions, wherein rendering the one or more images using the selected metadata comprises blending image attribute values together using blending weights.

35. The method of claim 34, wherein the blending weights are based on the angular distance between the rendering orientation and the one or more of the plurality of camera positions from which metadata was selected.

36. A decoder comprising:
a processor configured to:
receive a bitstream that comprises data representing a plurality of images, wherein the plurality of images were each captured from one of a plurality of camera positions, and wherein the bitstream comprises metadata that provides an indication of an image attribute associated with each of the plurality of camera positions;
select metadata based on an orientation for rendering one or more images at the decoder, wherein the rendering orientation is different from each of the plurality of camera positions; and
rendering the one or more images using the selected metadata.

37. The decoder of claim 36, the processor further configured to:
render the one or more images using the image attribute associated with at least one of the plurality of camera positions.

38. The decoder of claim 36, wherein the metadata is selected based on an angular distance between the rendering orientation and the plurality of camera positions.

39. The decoder of claim 38, wherein the selected metadata provides an indication of an image attribute associated with a camera position of the plurality of camera positions that has the smallest angular distance to the rendering orientation.

40. The decoder of claim 36, wherein the metadata is selected based on one or more of the plurality of camera positions, wherein rendering the one or more images using the selected metadata comprises blending image attribute values together using blending weights, wherein the blending weights are based on the angular distance between the rendering orientation and the one or more of the plurality of camera positions from which metadata was selected.
